(19) United States
(12) Patent Application Publication
(10) Pub. No.: US 2015/0012446 A1
(43) Pub. Date: Jan. 8, 2015

(54) METHOD AND DEVICE FOR DIGITAL REGISTRATION OF ASSETS

(71) Applicant: Tianjin Sursen Investment Co., Ltd., Tianjin (CN)

(72) Inventors: Tiejun HUANG, Beijing (CN); Donglin WANG, Tianjin (CN)

(21) Appl. No.: 14/324,114

(22) Filed: Jul. 4, 2014

(30) Foreign Application Priority Data
Jul. 4, 2013 (CN) 201310278022/X

(51) Int. Cl. G06Q 50/18; G06F 21/10; G06Q 10/00

(52) U.S. Cl. CPC G06Q 50/184; G06Q 10/00; G06F 21/105; G06F 2221/0768
USPC 705/310

(57) ABSTRACT

A method for digital registration of assets is provided by an embodiment of the present invention, including: receiving feature information and ownership information of an asset appointed by a user; wherein, the feature information is extracted from digital information of the asset and uniquely represents the asset; generating a digital ownership certificate of the asset according to the feature information and the ownership information of the asset; providing the digital ownership certificate and the digital ownership information of the asset to the user for his/her storage.

### CROSS-REFERENCE TO RELATED APPLICATION

This application claims priority from CN Patent Application Serial No. 201310278022.X, filed on Jul. 4, 2013, the entire contents of which are incorporated herein by reference for all purposes.

### FIELD OF THE INVENTION

The present invention is related to the technology of assets management and security, especially related to a method and device for digital registration of assets.

### BACKGROUND OF THE INVENTION

In the prior art, there are few methods for assets registration. For fixed assets, such as vehicles, houses, etc., the registration is usually performed in the form of issuing an official certificate.

For intellectual assets such as copyrights, although the ownership produces legal effect along with the producing of the intellectual assets, this method for registration is too traditional.

The current copyright registering system, such as online registering systems used by United States Copyright Office and National Copyright Administration of China, only provides authors with registration numbers for registered works (copyright objects).

By using registration numbers, the physical copyright objects or related papers are submitted to the Copyright Office within a certain period of time; and in case of a copyright action happens the submitted contents or objects are acquired from the Copyright Office.

### SUMMARY OF THE INVENTION

The embodiments of the present invention provide a method for digital registration of assets, which can be authenticated digitally.

A method for digital registration of assets provided by an embodiment of the present invention includes:

receiving feature information and ownership information of an asset appointed by a user; wherein, the feature information is extracted from digital information of the asset and uniquely represents the asset;

generating a digital ownership certificate of the asset according to the feature information and the ownership information of the asset;

providing the digital ownership certificate and the digital ownership information of the asset to the user for his/her storage.

A device for digital registration of assets provided by an embodiment of the present invention includes:

an acquiring module, adopted to acquire feature information which extracted from digital information of an asset appointed by a user, wherein the feature information uniquely represents the asset;

a generating module, adopted to generate a digital ownership certificate of the asset according to the feature information received and ownership information;

a storage module, adopted to store the digital ownership certificate of the asset;

a distributing module, adopted to provide the user with registration information of the asset for the user's storage.

In the technical scheme of the present invention, different kinds of assets are transformed to digital information, and the assets are digitally registered by issuing digital ownership certificates with feature information that uniquely represents the assets. When an asset is authenticated, it can simply authenticate whether the feature information of the asset matches the registered digital ownership certificate, without sending or authenticating physical asset.

### BRIEF DESCRIPTION OF THE DRAWINGS

To give a further description of the embodiments in the present invention or the prior art, the appended drawings used to describe the embodiments and the prior art will be introduced as follows. Obviously, the appended drawings described here are only used to explain the embodiments of the present invention. Those skilled in the art can understand that other appended drawings may be obtained according to these appended drawings without creative work.

FIG. 1 illustrates the flow chart of a method for digital registration of assets in an embodiment of the present invention.

FIG. 2 illustrates the flow chart of a method for digital registration of assets in another embodiment of the present invention.

FIG. 3 illustrates the flow chart of a method for digital registration of assets in another embodiment of the present invention.

FIG. 4 illustrates the flow chart of a method for re-issuing a digital ownership certificate of an asset in an embodiment of the present invention.

FIG. 5 illustrates the flow chart of a method for digital authentication of assets in an embodiment of the present invention.

### DETAILED DESCRIPTION OF THE INVENTION

To make the purpose, technical scheme and advantages of the present invention clearer, the technical solutions in the embodiments of the present invention are described clearly and fully hereinafter with reference to the accompanying drawings. Obviously the embodiments described hereinafter are only a part of the present invention. Based on the embodiments provided hereinafter, all other embodiments made by those skilled in the art without creative work should be considered within the protection scope of the present invention.

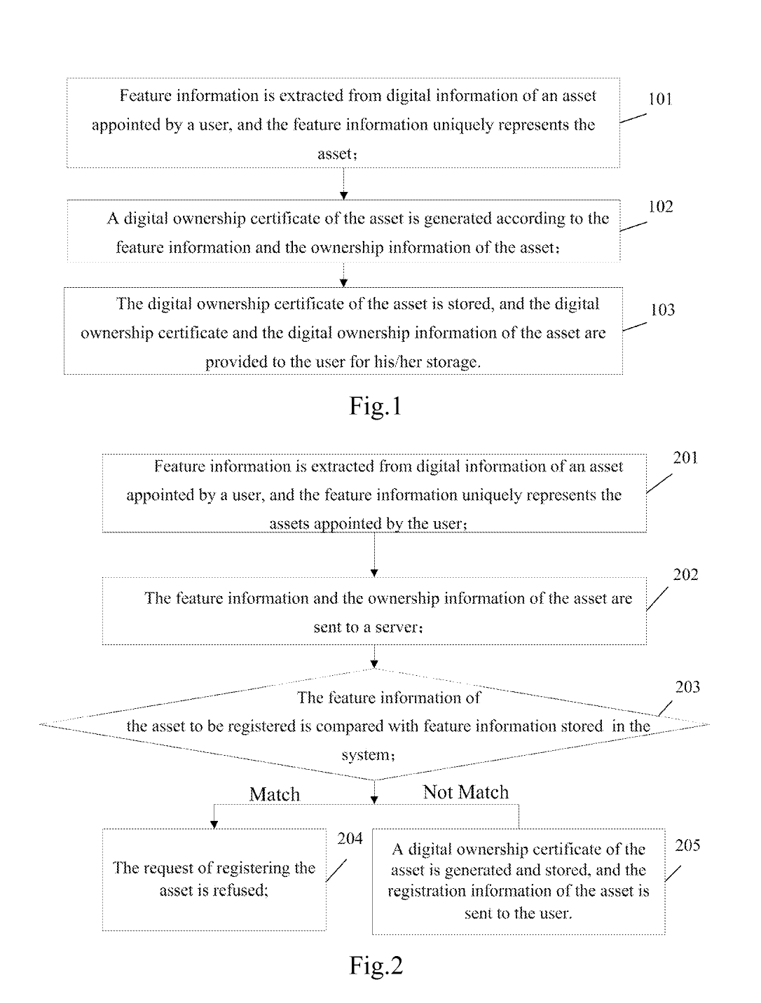

FIG. 1 illustrates the flow chart of a method for digital registration of assets in an embodiment of the present invention. As shown in FIG. 1, the method includes following steps.

Step 101: Feature information is extracted from digital information of an asset appointed by a user. The feature information uniquely represents the asset appointed by the user.

The digital information of the asset is the information digitally describing the asset, which may be a digital image of the asset in an example. In this case, a digital camera may be used to get digital images of the asset.

The feature information is the unique information that can be used to identify the asset and distinguish the asset from others.

Step 102: A digital ownership certificate of the asset is generated according to the feature information and the ownership information of the asset.

The ownership information of the asset is inputted by the user, which includes and is not limited to any or any combination of following information: description of the asset, description of the owner, registration time, time limitation of the ownership, etc.

Step 103: The digital ownership certificate of the asset is stored, and the digital ownership certificate and the digital ownership information of the asset are provided to the user for his/her storage.

By using the technical scheme of the present invention, any kind of assets (not limited to digital assets) can be digitally registered. For example, a personally collected treasure, which is not allowed to be shown in public, can be registered by submitting digital images of the treasure to the registration system. After extracting feature information from the digital images (for example the extracting may be implemented by calculating the Hash value of the digital images), a digital ownership certificate of the treasure is generated according to the feature information and the ownership information of the treasure. Then the digital ownership certificate is submitted to the registering administration to complete the registration. Thus in case that the treasure is lost the user can prove that the treasure belongs to him/her by using the digital ownership certificate. In this case, the user should claim in the segment of “description of the asset” that the object to be protected for the registration is the physical object shown in the digital images, but not the digital images themselves.

If the object to be protected for the registration is a digital asset, such as literature, arts, scientific works, digital images, polyphonic ringtone, MMS (multimedia message), online cartoon and game, (blog) online literature, video, 3-dimensional cartoon, etc., the user should claim in the segment of “description of the asset” that the object to be protected is the digital asset itself.

In an embodiment of the present invention, the above method may be implemented in a client/server mode, which includes a client of an asset owner and a server of the registering administration. In this case, Step 101 may be implemented on the client of the asset owner, and then the feature information and the ownership information of the asset are sent from the client to the server of the registering administration. Step 102 and Step 103 may be implemented on the server of the registering administration.

By using the technical scheme of the present invention, the physical asset or the complete information of the digital asset need not be transmitted; only feature information which uniquely represents the asset is transmitted between the asset owner and the registering administration. Thus the specific information of the asset will not be divulged (no privacy is divulged), so that the online registration can be considered safe.

In an embodiment of the present invention, the digital information of the asset may further include the surrounding environment information and/or the time information of the asset appointed. In this case, the surrounding environment information and/or the time information is recorded in the form of digital images. Thus when the asset is needed to be registered, the surrounding environment information and/or the time information can be used to confirm the ownership of the asset.

FIG. 2 illustrates the flow chart of a method for digital registration of assets in another embodiment of the present invention. As shown in FIG. 2, the method includes following steps.

Step 201: Feature information is extracted from digital information of an asset appointed by a user. The feature information uniquely represents the assets appointed by the user.

Step 202: The feature information and the ownership information of the asset are sent to a server.

Step 203: The feature information of the asset to be registered is compared with feature information having been registered in the system to determine whether the asset has been registered before, if there is feature information in the system same with that of the asset to be registered, it means the asset has been registered before and Step 204 is executed; otherwise, continue with Step 205.

Step 204: The request of registering the asset is refused.

Step 205: A digital ownership certificate of the asset is generated and stored, and the registration information (the digital ownership certificate and the digital ownership information) of the asset is transmitted to the user.

By using the technical scheme of the present invention, a repeated registration of the same asset is avoided, so that the cost of the registration is reduced and the social resources are optimized, and more importantly, the user can understand the value of his/her own asset quickly.

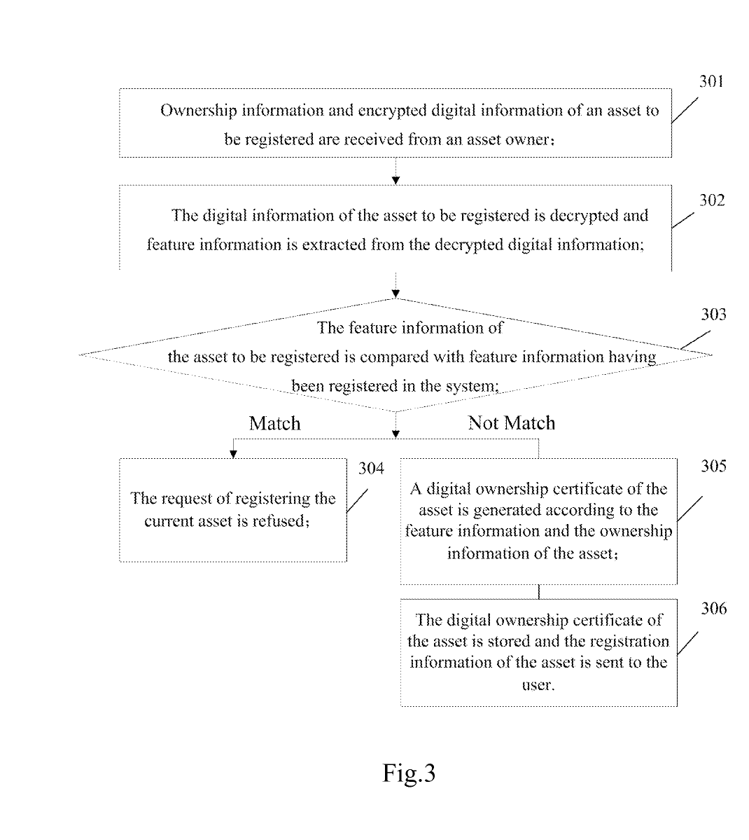

FIG. 3 illustrates the flow chart of a method for digital registration of assets in another embodiment of the present invention. As shown in FIG. 3, the method includes following steps.

Step 301: Ownership information and encrypted digital information of an asset to be registered are received from an asset owner.

In an embodiment of the present invention, digital information and ownership information of the asset are encrypted and submitted from the client of the asset owner.

Step 302: The digital information of the asset to be registered is decrypted and feature information is extracted from the decrypted digital information.

Step 303: The feature information of the asset to be registered is compared with feature information having been registered in the system to determine whether the asset has been registered before, if there is feature information in the system same with that of the asset to be registered, it means the asset has been registered before and Step 304 is executed; otherwise, continue with Step 305.

Step 304: The request of registering the current asset is refused.

Step 305: A digital ownership certificate of the asset is generated according to the feature information and the ownership information of the asset.

Step 306: The digital ownership certificate of the asset is stored and the registration information (the digital ownership certificate and the digital ownership information) of the asset is transmitted to the user.

Due to feature information extracting method, there are not absolutely same pieces of feature information; most likely, there are similar pieces of feature information extracted. In this case, when the similarity between the feature information of the asset to be registered and that having been registered in the system is beyond a preset range, Step 205 or Step 305 is implemented; when the similarity is within the preset range, Step 204 or Step 304 is implemented. In an embodiment of the present invention, Step 204 or Step 304 may include: refusing the request of registering the current asset and terminating the registering process; Or in another embodiment of the present invention, informing the user that “same or similar assets have been registered”, which can provide the user a chosen whether to continue the registration or not. If the user chooses to continue the registration, Step 205 or Step 305 is then implemented.

In an embodiment of the present invention, encrypted digital information of the asset is stored, and then the digital information of the asset is provided to the user according to the user's request.

In an embodiment of the present invention, digital information of the asset is not encrypted on the client of the asset owner; however, the safety is ensured by encrypting communication channels during the network transmission. In this case, the information received by the server is the plaintext of the digital information of the asset; before storing the digital information, the server encrypts the plaintext of the digital information.

The technical scheme provided by above embodiments of the present invention may also be applied in a judgment of an asset infringement, which can make the judgment more objective.

In an embodiment of the present invention, to meet a request of an asset owner or other third parties (such as judges or property purchasers), the asset is compared with other assets including the registered assets to obtain the similarity between them, and a comparing report or a certificate is generated according to the comparing results.

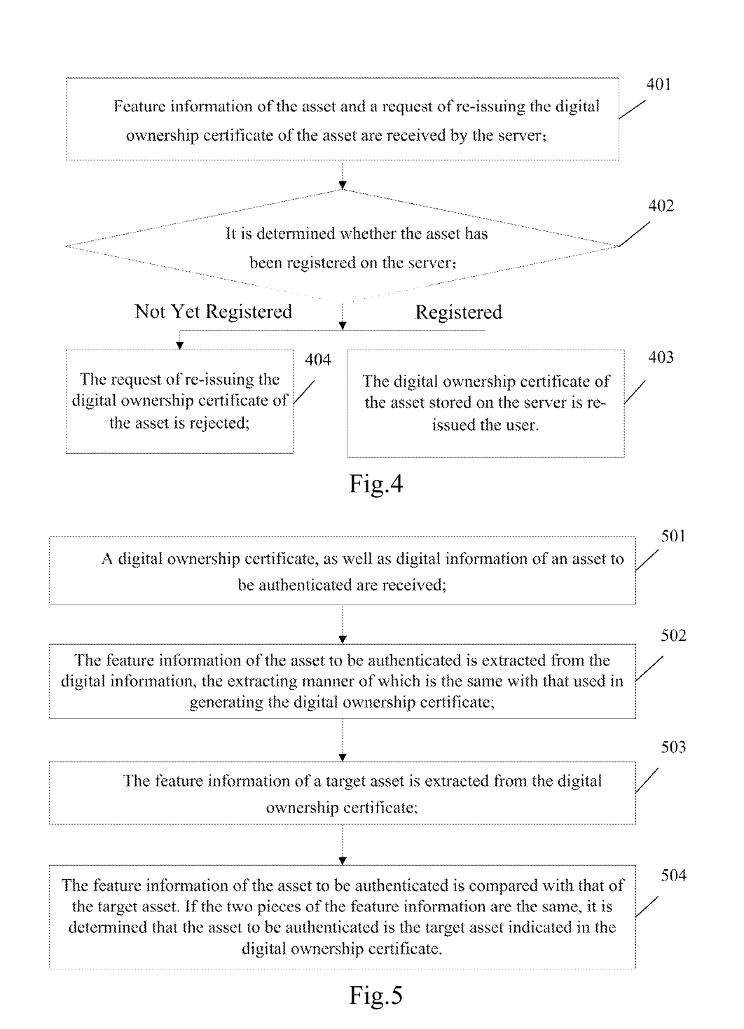

FIG. 4 illustrates the flow chart of a method for re-issuing a digital ownership certificate of an asset in another embodiment of the present invention. As shown in FIG. 4, after an asset is registered and the digital ownership certificate of the asset is lost, the digital ownership certificate can be re-issued by following steps.

Step 401: Feature information of the asset and a request of re-issuing the digital ownership certificate of the asset are received by the server.

Step 402: It is determined whether the asset has been registered on the server, the determination may be made by using the technical scheme provided in above embodiments of the present invention; if it is determined that the asset has been registered on the server, continue with Step 403; otherwise, continue with Step 404.

Step 403: The digital ownership certificate of the asset stored on the server is re-issued the user.

Step 404: The request of re-issuing the digital ownership certificate of the asset is rejected.

Those skilled in the art can understand that, after Step 404, the system can automatically remind the user to register the asset; the registering process may be the same as those described in the above embodiments.

FIG. 5 illustrates the flow chart of a method for digital authentication of assets in an embodiment of the present invention. The digital authentication method is used to determine whether an asset (to be authenticated) is the target asset of a digital ownership certificate according to the digital ownership certificate and digital information of the asset to be authenticated. The method includes following steps.

Step 501: The digital ownership certificate of the target asset, as well as the digital information of the asset to be authenticated are received.

Step 502: The feature information of the asset to be authenticated is extracted from the digital information, the extracting manner of which is the same with that used in generating the digital ownership certificate of the target asset.

Step 503: The feature information of the target asset is extracted from its digital ownership certificate.

In an embodiment of the present invention, a public key, corresponding to a private key which is used to generate the digital ownership certificate, is public and can be used to decrypt the digital ownership certificate to obtain the feature information of the target asset.

Step 504: The feature information of the asset to be authenticated is compared with that of the target asset. If the two pieces of the feature information are the same, it is proved that the asset to be authenticated is the target asset indicated in the digital ownership certificate.

In an embodiment of the present invention, extracting manners of feature information used at different time may be recorded by the system, so that in a subsequent comparing process, the extracting manner used at a certain time can be obtained according to the generating time recorded of the digital ownership certificate.

The methods for digital authentication of assets provided by above embodiments may be completely implemented on the server side; in this case, the digital authentication of assets can be provided as an online service.

The methods for digital authentication of assets may also be performed offline. In this case, even when the system is not connected with the server side, an asset to be authenticated may also be determined whether it is the target asset of a digital ownership certificate.

Thus, in an embodiment of the present invention, when comparing the feature information of an asset to be authenticated with the feature information extracted from a digital ownership certificate, a strict matching requirement may be applied. For example, when the extracting manner is calculating the hash value and/or fingerprint of the digital information of the asset, the two pieces of the feature information are determined as the same only when the hash value and fingerprint of them are 100% matched.

In practical cases, it is not common that two assets are totally the same; most likely, two assets may be regarded as the same as long as the core parts of them are the same. For example, some pirates may compress legal video works to evade regulation. In this case, the hash value of the piratical video work may be different from that of the legal video work, however the media fingerprints of them may be the same. Therefore in an embodiment of the present invention, a non-strict matching requirement may be applied to compare the feature information of the asset to be authenticated with that extracted from the digital ownership certificate. As long as the media fingerprints of them match, the two pieces of feature information may be considered the same.

In an embodiment of the present invention, none of auxiliary information is added to the digital information of the asset; however, the asset is identified by the nature of its digital information, i.e., the feature information that uniquely represents the asset is obtained only according to the digital information of the asset.

In an embodiment of the present invention, the feature information that uniquely represents the asset may be extracted by calculating the hash value of the digital information of the asset.

In another embodiment of the present invention, the feature information that uniquely represents the asset may be extracted by obtaining features of its contents by using a feature extracting algorithm.

In another embodiment of the present invention, digital information of the asset is not limited to images; it may also include texts, software, software codes, audios, videos, graphic designs, 3D graphics or scenes, etc. Thus the feature information of the asset may be extracted by using different types of algorithms. For example, Scale Invariant Feature Transform (indicated as SIFT for short), an algorithm used for detecting and describing regional features of an image in the computer vision field, may be applied. By using SIFT algorithm, a stable key point is chosen from extreme points in the scale space, and the descriptor of the key point is calculated with reference to surrounding points, so that high distinction and better robustness may be guaranteed. Based on the principle of SIFT algorithm, feature information exacting algorithm of the image may be determined, and the most stable regional feature points which extracted from the scale space is considered as the feature information (image pattern). The image pattern may be compared based on a principle that area ratio of an affine transformation never changes.

A device for digital registration of assets provided by an embodiment of the present invention includes:

an acquiring module, adopted to acquire feature information which extracted from digital information of an asset appointed by a user, wherein the feature information uniquely represents the asset;

a generating module, adopted to generate a digital ownership certificate of the asset according to the feature information received and ownership information;

a storage module, adopted to store the digital ownership certificate of the asset;

a distributing module, adopted to provide the user with registration information of the asset for the user's storage, wherein the registration information includes the number of the digital ownership certificate, the digital ownership information and so on.

In an embodiment of the present invention, the device is set on a server side of the server provider. In another embodiment of the present invention, a feature information extracting module may be further included, adopted to extract feature information from digital information of an asset appointed by a user. The feature information extracting module may be set on a client side of the user or on a server side.

In an embodiment of the present invention, the device may further include:

a receiving module, adopted to receive digital information of an asset to be registered;

a storage module, adopted to store the digital information of the asset to be registered;

In an embodiment of the present invention, the device further includes:

a comparing module, adopted to compare the feature information of the asset to be registered with feature information stored in the storage module, determine whether there is a digital ownership certificate with the same or similar feature information as that of the asset to be registered, and send the comparing result to different modules to achieve different functions.

In an embodiment of the present invention, the device further includes:

a request receiving module, adopted to receive the user's requests for different requirements, such as a request of re-issuing a digital ownership certificate, a request of registering an asset to obtain a digital ownership certificate or an request of authenticating an asset.

In an embodiment of the present invention, the device further includes:

re-issuing module, adopted to invoke the comparing module to compare the feature information of the asset with feature information of registered assets stored in the storage module when the request receiving module receives a re-issuing request; and invoke the distributing module to send the digital ownership certificate of the asset stored in the storage module to the user when the result returned from the comparing module shows there is a digital ownership certificate with same or similar feature information stored in the storage module.

In an embodiment of the present invention, the device further includes:

a registering module, adopted to invoke the comparing module to compare the feature information of the asset with feature information of registered assets stored in the storage module when the request receiving module receives a registering request; invoke the generating module to generate a digital ownership certificate of the asset and store it in the storage module, and then invoke the distributing module to send the generated digital ownership certificate of the asset to the user when the result returned from the comparing module shows there is not a digital ownership certificate with same or similar feature information stored in the storage module.

an authenticating module, adopted to invoke the comparing module to compare the feature information of the asset with feature information of registered assets stored in the storage module and send the comparing result to the user, when the request receiving module receives an authenticating request.

In an embodiment of the present invention, a relatively independent device for digital authentication of assets is provided. The device includes:

a storage module, adopted to record extracting manners of feature information applied at different times;

a receiving module, adopted to receive a digital ownership certificate, as well as digital information of an asset to be authenticated;

a feature extracting module, adopted to extract feature information from the digital information of the asset to be authenticated, by using the extracting manner applied to generate the digital ownership certificate;

a decrypting module, adopted to extract feature information from the digital ownership certificate;

a comparing module, adopted to compare the feature information of the asset to be authenticated with that exacted from the digital ownership certificate, if the two pieces of feature information are the same, determine that the asset to be authenticated is the target asset indicated in the digital ownership certificate.

Those skilled in the art can understand that, all or part of the steps in above embodiments may be implemented by hardware instructed by software programs. The programs may be stored in a readable storage medium. When the programs are executed, the steps in above embodiments are implemented. The readable storage medium may include: ROM, RAM, disk, CD and other medium that stores the program code.

Finally, the above embodiments are used barely for clarity and not as limitation to the invention. Although the invention is explained clearly with reference to the detail description of the embodiments, those skilled in the art can understand that, the technical scheme of the embodiment may still be modified or partly equivalently substituted; and the modification or substitution should be considered within the spirit and protection scope of the present invention.

1. A method for digital registration of assets, comprising:
receiving feature information and ownership information of an asset appointed by a user; wherein, the feature information is extracted from digital information of the asset and uniquely represents the asset;
generating a digital ownership certificate of the asset according to the feature information and the ownership information of the asset;
providing the digital ownership certificate and the digital ownership information of the asset to the user for his/her storage.

2. The method of claim 1, wherein, the digital information of the asset comprises: digital images, texts, software, software codes, audios, videos, graphic designs and 3D graphics or scenes.

3. The method of claim 2 wherein, the digital information of the asset further comprises: surrounding environment information and/or time information.

4. The method of claim 1, wherein, the digital information of the asset comprises: digital images of the asset, and/or digital images of surrounding environment information and/or time information of the asset.

5. The method of claim 1, wherein, the ownership information of the asset comprises any or any combination of following information: description of the asset, description of the owner, registration time and time limitation of the ownership.

6. The method of claim 1, wherein, after receiving feature information and ownership information and before generating a digital ownership certificate, the method further comprises:
comparing the feature information of the asset to be registered with feature information stored in the system.

7. The method of claim 6, wherein, when comparing the feature information of the asset with feature information having been registered in the system, a strict or non-strict matching requirement may be applied;
wherein, the non-strict matching requirement means as long as the media fingerprints of them match, the two pieces of feature information are considered the same.

8. The method of claim 1, further comprising:
receiving feature information and a request of re-issuing a digital ownership certificate of an asset from a user;
comparing the feature information of the asset with feature information having been registered in the system; wherein, the comparing result shows that there is feature information in the system same with that of the asset;
re-issuing the digital ownership certificate of the asset with the registered feature information to the user.

9. The method of claim 1, wherein, the feature information that uniquely represents the asset is extracted by calculating the hash value of the digital information of the asset.

10. The method of claim 1, wherein, the feature information that uniquely represents the asset is extracted by obtaining features of its contents by using a feature extracting algorithm.

11. The method of claim 1, further comprising:
receiving a digital information of an asset to be authenticated and a digital ownership certificate;
extracting feature information of the asset to be authenticated from the digital information, the extracting manner of which is the same with that used in generating the digital ownership certificate;
extracting the feature information of a target asset from the digital ownership certificate;
comparing the feature information of the asset to be authenticated with that of the target asset;
determining that the asset to be authenticated is the target asset indicated in the digital ownership certificate if the two pieces of the feature information are the same.

12. The method of claim 11, the method further comprising:
recording the extracting manners of feature information used at different time.

13. The method of claim 1, wherein, the digital information is encrypted before sent, and then is decrypted before the feature information is extracted.

14. A device for digital registration of assets, comprising:
an acquiring module, adopted to acquire feature information which extracted from digital information of an asset appointed by a user, wherein the feature information uniquely represents the asset;
a generating module, adopted to generate a digital ownership certificate of the asset according to the feature information received and ownership information;
a storage module, adopted to store the digital ownership certificate of the asset;
a distributing module, adopted to provide the user with registration information of the asset for the user's storage.

15. The device of claim 15, further comprising:
a feature information extracting module, adopted to extract feature information from the digital information of the asset.

16. The device of claim 15, further comprising:
a receiving module, adopted to receive the digital information of the asset to be registered;
a storage module, adopted to store the digital information of the asset to be registered.

17. The device of claim 15, further comprising:
a comparing module, adopted to compare the feature information of the asset to be registered with feature information stored in the storage module, determine whether there is a digital ownership certificate with the same or similar feature information as that of the asset to be registered, and send the comparing result to different modules to achieve different functions.

18. The device of claim 18, further comprising:
a request receiving module, adopted to receive the user's requests for different requirements, such as a request of re-issuing a digital ownership certificate, a request of registering an asset to obtain a digital ownership certificate or an request of authenticating an asset.

19. The device of claim 19, further comprising:
re-issuing module, adopted to invoke the comparing module to compare the feature information of the asset with feature information of registered assets stored in the storage module when the request receiving module receives a re-issuing request; and invoke the distributing module to send the digital ownership certificate of the asset stored in the storage module to the user when the result returned from the comparing module shows there is a digital ownership certificate with same or similar feature information stored in the storage module;
a registering module, adopted to invoke the comparing module to compare the feature information of the asset with feature information of registered assets stored in the storage module when the request receiving module receives a registering request; invoke the generating module to generate a digital ownership certificate of the asset and store it in the storage module; and then invoke the distributing module to send the generated digital ownership certificate of the asset to the user, if the result returned from the comparing module shows there is not a digital ownership certificate with same or similar feature information stored in the storage module;
an authenticating module, adopted to invoke the comparing module to compare the feature information of the asset with feature information of registered assets stored in the storage module, and send the comparing result to the user, when the request receiving module receives an authenticating request.

20. The device of claim 19, further comprising:
a storage module, adopted to record extracting manners of feature information applied at different times;
a receiving module, adopted to receive a digital ownership certificate, as well as digital information of an asset to be authenticated;
a feature extracting module, adopted to extract feature information from the digital information of the asset to be authenticated, by using the extracting manner applied to generate the digital ownership certificate;
a decrypting module, adopted to extract feature information from the digital ownership certificate;
a comparing module, adopted to compare the feature information of the asset to be authenticated with that exacted from the digital ownership certificate, if the two pieces of feature information are the same, determine that the asset to be authenticated is the target asset indicated in the digital ownership certificate.
